(19) United States
(12) Patent Application Publication
(10) Pub. No.: US 2011/0273886 A1
(43) Pub. Date: Nov. 10, 2011

(54) LUMINAIRE HAVING NON-REVEALED AREA LIGHT SOURCES

(76) Inventors: Min-Hao Michael Lu, Oakland, CA (US); Darren Blum, Foster City, CA (US); Peter Y.Y. Ngai, Alamo, CA (US); Michael Trung Tran, Oakland, CA (US)

(21) Appl. No.: 13/103,946

(22) Filed: May 9, 2011

Related U.S. Application Data
(60) Provisional application No. 61/332,660, filed on May 7, 2010.

(51) Int. Cl. F21S 4/00; F21V 15/01

(52) U.S. Cl. 362/249.02; 362/362; 362/249.01

(57) ABSTRACT

A luminaire has a shell housing with an upper shell section and a lower shell section that form an interior cavity and at least one side opening through which an observer can see into the interior cavity of the shell housing from a position below the luminaire when the luminaire is positioned overhead the observer. The interior cavity has a lower region which is hidden from the direct line-of-sight of an observer below the luminaire. At least one and suitably a plurality non-revealed upwardly facing area light sources, such as OLEDs, are supported on the lower shell section of the shell housing and disposed in the lower region of the interior cavity thereof so as to produce light within the interior cavity and so as to be hidden from the direct line-of-sight of an observer below the luminaire. Upwardly facing non-revealed area light sources can also be provided on the upper shell section of said shell housing for producing light that is directed overhead the luminaire from said upper shell section from additional area light sources that are hidden from the direct line-of-sight of an observer below the luminaire.

### CROSS-REFERENCE TO RELATED APPLICATIONS

This application claims the benefit of U.S. Provisional Patent Application No. 61/332,660 filed May 7, 2011, which is incorporated herein by reference.

### BACKGROUND OF THE INVENTION

The present invention generally relates to luminaires for general lighting and more particularly luminaires using organic light emitting diodes (OLEDs) or the like as a light source.

Because of their lower luminance, area light sources such as OLEDs and edge-coupled LEDs are typically used in applications where they can be directly viewed. However, direct viewing of area light sources has particular disadvantages: because of imperfections that can occur in the manufacturing process, the light emitting surfaces of the area sources are often aesthetically unappealing and therefore diminish the appeal of the overall luminaire. Examples of such imperfections include luminance variations, color variations, and variations in the angular dependence of luminance and color. These variations can occur within each area source panel or from panel to panel.

Semiconductor manufacturers such as Si microprocessor or inorganic LED manufacturers have traditionally addressed these variations by post fabrication testing and grading—a practice known in the industry as “binning”. Premium grade, or higher binned, products command a price premium and vice versa. System integrators, PC makers in the case for Si microprocessors, and LED luminaire makers in the case of the inorganic LEDs, have typically specified a single grade of components for their products.

### SUMMARY OF INVENTION

The present invention allows for the use of area light sources, and most suitably OLED light sources, in a luminaire for general lighting in a manner that is more tolerant of variations in the manufacturing process for such light sources. The luminaire of the invention particularly allows lower grade sources to be used without compromising the aesthetic quality of the luminaire, thus lowering materials cost for the luminaire and permitting the luminaire manufacturer to better manage the sourcing of this component part of the luminaire. In a further aspect of the invention, non-revealed area light sources can be used to provide a luminaire with special lighting accents in addition to contributing to the total lumen output of the luminaire.

### BRIEF DESCRIPTION OF THE DRAWINGS

FIG. 1 is an exploded side elevational view of a luminaire having non-revealed OLED light sources.

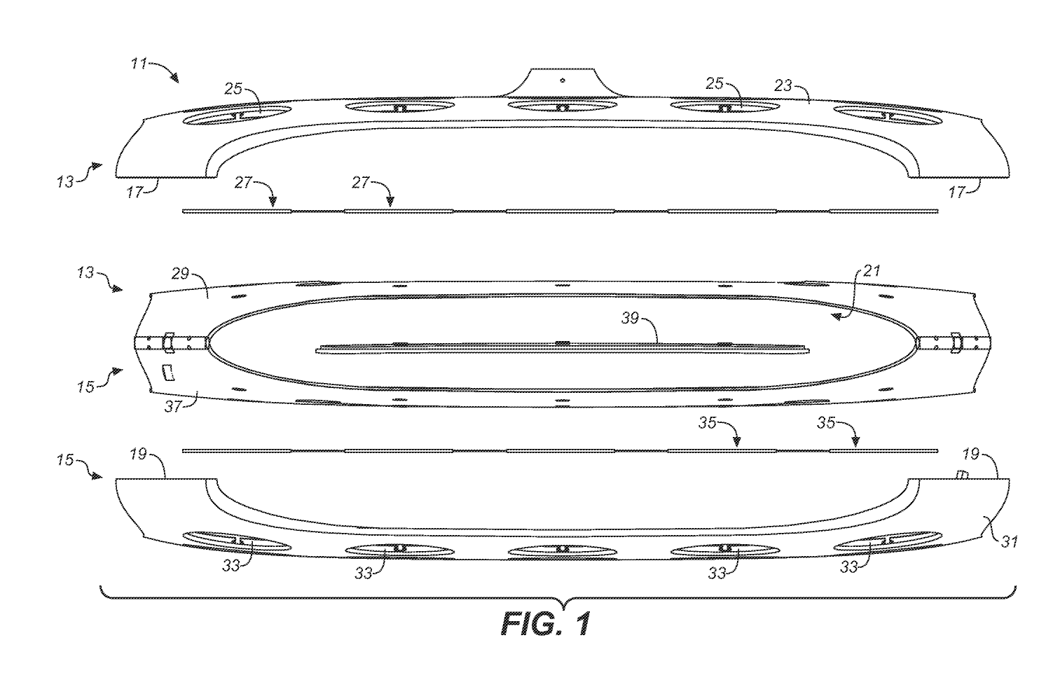

FIG. 2 is an exploded perspective view thereof.

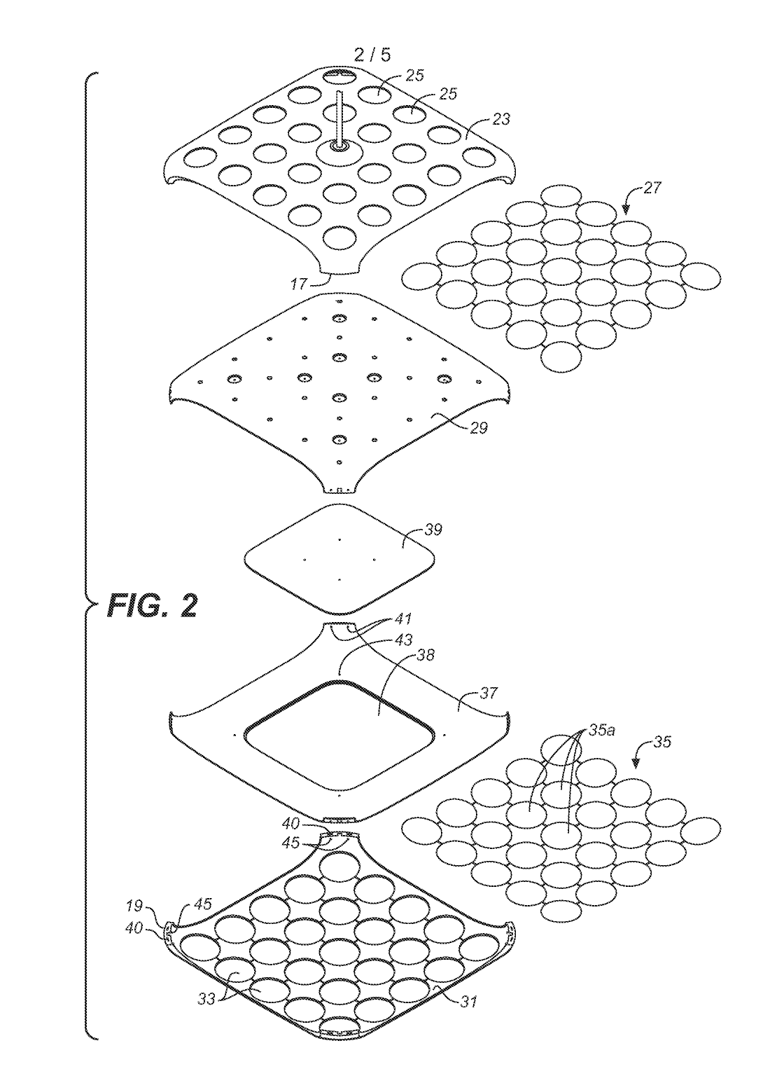

FIG. 3 is another exploded perspective view thereof.

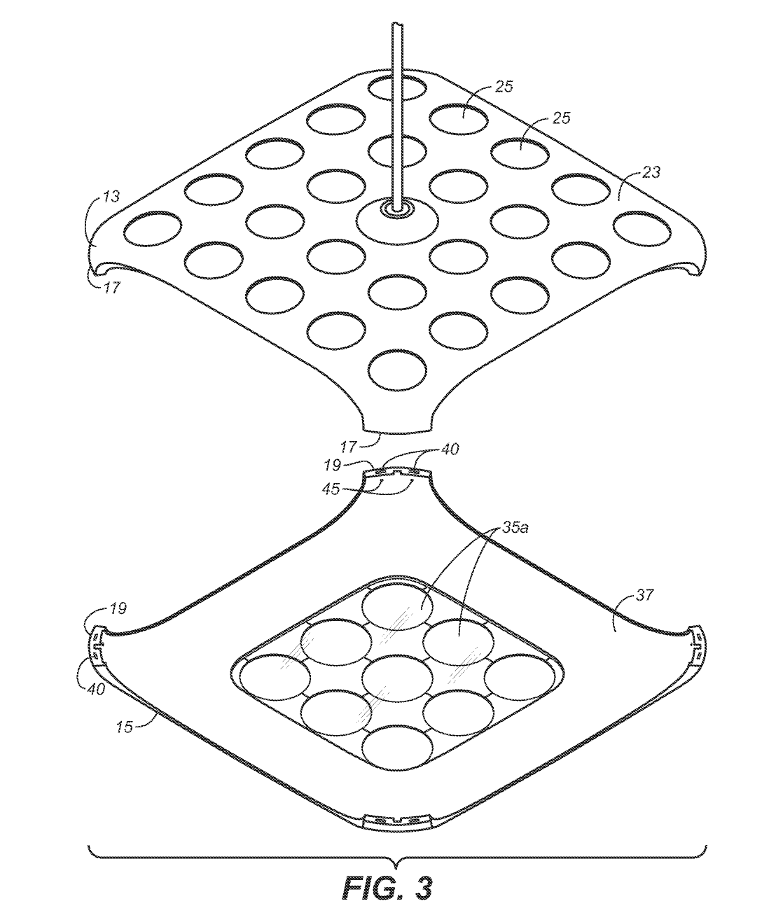

FIG. 4 is a top perspective view of the luminaire shown in FIGS. 1-3 fully assembled.

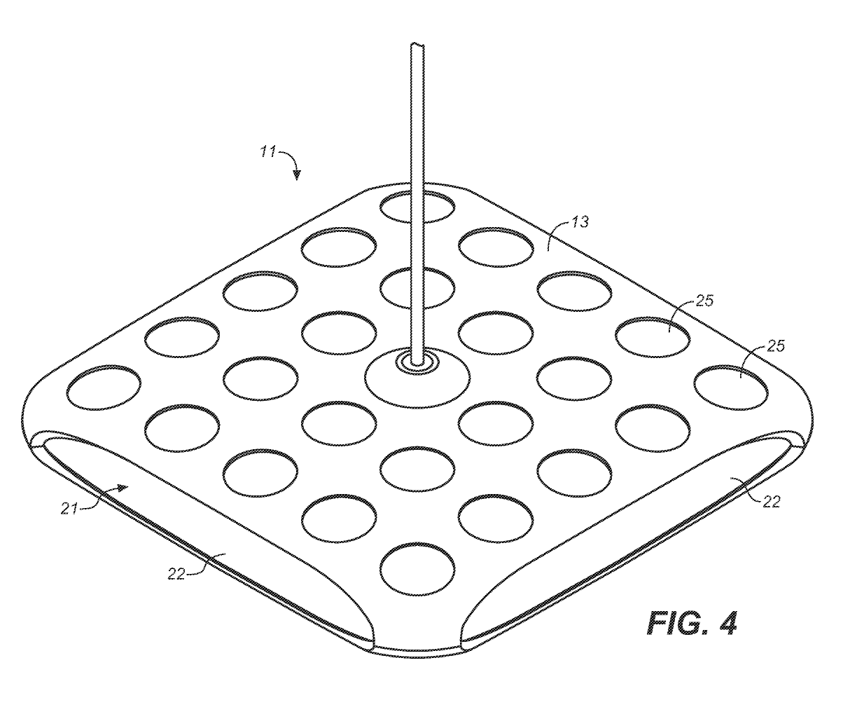

FIG. 5 is a side elevational view thereof.

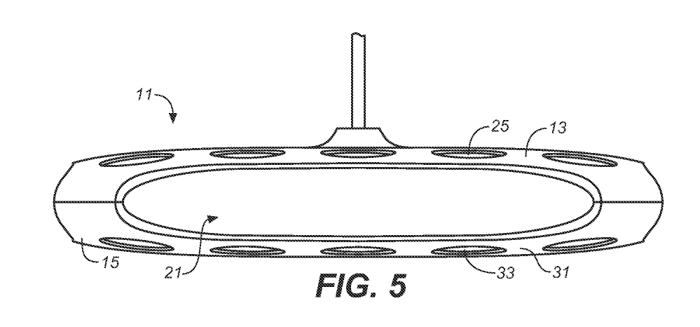

### DESCRIPTION OF THE ILLUSTRATED EMBODIMENT

The drawings illustrate a luminaire having a plurality of OLED light sources wherein a significant portion of the sources are located on the luminaire so that they both contribute to the total lumen output of the luminaire and provide a lighting accent, but at the same time are not revealed to observers in the vicinity of the luminaire who view to luminaire at normal viewing angles. The illustrated luminaire is suitably suspended from an overhead ceiling structure above the observer of the luminaire, typically 1-2 feet below the ceiling, where the top and other portions of the luminaire would be out of the line-of-sight of the observer.

Referring to the drawings, luminaire 11 is seen to have upper and lower clam-shaped sections 13, 15, which are joined together at their interior corner edges 17, 19 to form a pod-shaped thin-walled clam shell housing assembly having an interior cavity 21, into which an observer can see from a position below the luminaire. At normal viewing angles, the observer will see the upper regions of the interior cavity through the side openings 22 of the clam shell assembly, and not the lower regions. This will allow OLED panels to be place in the lower regions of the internal cavity as hereinafter described, where they are out of the line-of-sight of the observer.

The upper shell section 13 of the luminaire is seen to include an upper clam-shaped shell 23 having a plurality of area light apertures 25, a plurality of OLED light panels 27 set into the light apertures 25 suitably on recessed support ledges (not shown) within the apertures, and an upper clam-shaped cover plate 29 securable to the underside of the upper shell 23 for holding the OLED panels in place in the clam shell apertures 25. Similarly, the lower section 15 of the luminaire is seen to include a lower clam-shaped shell 31 having a plurality of area light apertures 33, a plurality of OLED light panels 35 set into the apertures 33 suitably on recessed support ledges (not shown) within the apertures, and a lower clam-shaped cover plate 37 securable to the inside of the lower shell 31 for holding the OLED panels 35 in place in apertures 33.

In the case of the lower section, the cover plate 37 has a central opening 38 for exposing the center-most apertures 33a (nine in the illustrated embodiment) to the interior cavity 21 of the clamshell assembly. Back-to-back OLED panels 35a are set into these center-most apertures such that light generated by the top one of the back-to-back OLEDs is directed into the interior cavity. The back-to-back OLEDs are covered and held in place by a separate center cover plate 39, which is transparent. The light emitting top surfaces of the back-to-back OLEDs are seen to be tucked down into the lower region of the interior cavity where they are out of the line-of-sight of the observer. It will be understood that “back-to-back OLEDs” as described above can be separate OLED panels placed in a back-to-back relation, or a single OLED panel that emits light from both sides of the panel.

The light emitting surfaces of the OLED panels 27 in the upper shell of the luminaire will similarly be out of the line-of-sight of the observer, as these OLEDs face upwardly from the top of the shell housing toward the overhead ceiling. Thus, in the illustrated luminaire, contributions to the total lumen output of the luminaire are made by non-revealed OLEDs that make of over 50% of the total light emitting surface area of the OLEDs. (In the illustrated embodiment, each OLED has the substantially the same light emitting surface area.) The lumen output from the non-revealed OLED panels not only produce a component of indirect lighting, but also a lighting accent by the lighting of observable interior surfaces of interior cavity 21, which can be proved with different textures and colors for a desired visual effect. All of the OLEDs used in the non-revealing locations of the luminaire (OLEDs 25 in upper clam shell section 23 and the top the OLEDs of the back-to-back OLEDs 35a) can be selected from less expensive lower grade OLEDs, thereby lowering the materials cost of the luminaire.

The upper and lower shells 23, 31 and the upper and lower cover plates 29, 37 of upper and lower shell sections 13, 15 of the shell housing can suitably be fabricated of a plastic material such as acrylonitrile butadiene styrene (ABS). The center cover plate 39 for covering the upwardly facing OLEDs in the cover opening 39 in the lower shell section can suitably be fabricated of clear acrylic plastic or PVC plastic. Wiring of the OLEDs can be accomplished through wire chases in the upper and lower shells 23, 37, such as the self-capturing wire chases disclosed in commonly owned and co-pending application Ser. No. 13/103,804 filed May 9, 2011, which is incorporated herein by reference. The lower shell section 15 can be electrically connected to the upper shell section through wire connections in one or more of the corner edges 17, 19 of upper and lower shells 23, 31. Suitably the shells 23, 31 are thicker than the inner cover plates 29, 37; for example the shells could be in the range of ⅜ inch thick and the cover plates in the range of ⅛ inch thick. Quick connectors can be provided in the shell corner edges 17, 19 to establish an electrical connection when the shells are joined together.

To assemble the luminaire 11, the OLED panels can first be installed in the upper and lower shells shell sections 13, 15, and the cover plates 29, 31 secured to the underside of the shells by suitable means, such as by screw attachments. Screw holes, such as holes denoted 43 on the lower cover plate 37, can be provided in the cover plates and the shells for this purpose. (The covers could alternatively be sized to press fit into the curved undersides of the shells.) The interior edges of the shells can then be joined together by any suitable means. For example, dowel pins such as oblong aluminum dowel pins can be inserted in correspondingly shaped dowel holes 40 in the corner edges 19 of the shell 31 of the lower shell section 15 so that they project up from these corner edges. The corner edges of the upper shell section can be provided with corresponding dowel holes that fit down over the projecting dowel pins in the lower shell when the corner edges of the two halves of the shell housing are fitted together. The edges can then be locked in place by set screws, which screw into set screw holes 41, 45 on the interior corners on the cover plates and shells. The set screws, which can be inserted by reaching through the side openings 22 of the shell housing, are screwed into the dowel pins.

It will be understood that OLED panels or other area light sources could be secured in the upper and lower shell sections of the luminaire described above by means other than described to produce non-revealed light sources, and that the non-revealed OLED panels could overlay the walls of the one or both shells rather than being inset into apertures within the shells. It will also be appreciated that instead of a center opening 38 the cover plate 37 could have a non-centered opening or more than one opening in correspondence to which back-to-back OLEDs are provided for illuminating the interior cavity of the shell housing.

While the invention has been described in considerable detail in the foregoing specification and drawings, it will be understood that it is not intended that the invention be limited to such detail, except as necessitated by the following claims.

We claim:

1. A luminaire comprising
a shell housing having an upper shell section and a lower shell section that form an interior cavity and at least one side opening through which an observer can see into the interior cavity of the shell housing from a position below the luminaire when the luminaire is positioned overhead the observer, said interior cavity having a lower region which is hidden from the direct line-of-sight of an observer below the luminaire, and
at least one non-revealed upwardly facing area light source supported on lower shell section of said shell housing and disposed in the lower region of the interior cavity thereof so as to produce light within said interior cavity and so as to be hidden from the direct line-of-sight of an observer below the luminaire.

2. The luminaire of claim 1 further comprising at least one upwardly facing non-revealed area light source on the upper shell section of said shell housing for producing light that is directed overhead the luminaire from said upper shell section from an area light source that is hidden from the direct line-of-sight of an observer below the luminaire.

3. The luminaire of claim 1 further comprising at least one downwardly facing revealed area light source on the lower section of said luminaire for directing light directly into the space below the luminaire.

4. The luminaire of claim 3 wherein the non-revealed area light source and revealed area light source on the lower shell section of said shell housing are provided by back-to-back area light sources.

5. The luminaire of claim 1 wherein shell housing side openings on all sides of the shell housing such that an observer can see into the interior cavity of the shell housing from any side of the housing.

6. The luminaire of claim 1 wherein said area light source is comprised of an OLED panel.

7. The luminaire of claim 1 wherein a plurality of non-revealed area light sources are provided on the lower shell section of said shell housing.

8. A luminaire comprising
a shell housing having an upper shell section and a lower shell section that form an interior cavity and side openings through which an observer can see into the interior cavity of the shell housing from a position below the luminaire when the luminaire is positioned overhead the observer, said interior cavity having a lower region which is hidden from the direct line-of-sight of an observer below the luminaire,
a plurality of downwardly facing revealed area light source on the lower section of said luminaire for directing light directly into the space below the luminaire, said plurality of revealed area light sources including back-to-back light sources that provide non-revealed upwardly facing area light sources disposed in the lower region of the interior cavity thereof so as to produce light within said interior cavity and so as to be hidden from the direct line-of-sight of an observer below the luminaire.

9. The luminaire of claim 8 further comprising upwardly facing non-revealed area light source on the upper shell section of said shell housing for producing light that is directed overhead the luminaire from said upper shell section from an area light source that is hidden from the direct line-of-sight of an observer below the luminaire.

10. The luminaire of claim 9 wherein said area light sources are comprised of OLED panels.

11. The luminaire of claim 8 wherein said upper and lower shell sections are separable sections joined together to form said shell housing.

12. The luminaire of claim 11 wherein said lower shell section is comprises of a lower shell having apertures into which area light sources are set and a lower securable to the inside of the lower cover plate means for holding said area light sources in said apertures, said cover plate means being transparent where it covers the back-to-back area light sources in said lower shell section.

13. A luminaire comprising
a shell housing having an upper shell section and a lower shell section that form an interior cavity and at least side openings through which an observer can see into the interior cavity of the shell housing from a position below the luminaire when the luminaire is positioned overhead the observer, said interior cavity having a lower region which is hidden from the direct line-of-sight of an observer below the luminaire,
a plurality of non-revealed upwardly facing area light source supported on lower shell section of said shell housing and disposed in the lower region of the interior cavity thereof so as to produce light within said interior cavity and so as to be hidden from the direct line-of-sight of an observer below the luminaire, and
a plurality of upwardly facing non-revealed area light source on the upper shell section of said shell housing for producing light that is directed overhead the luminaire from said upper shell section from an area light source that is hidden from the direct line-of-sight of an observer below the luminaire.

14. The luminaire of claim 13 wherein said area light sources are comprised of OLED panels.

15. The luminaire of claim 13 wherein said upper and lower shell sections are separable sections joined together to form said shell housing.
